(19) United States
(12) Patent Application Publication
(10) Pub. No.: US 2009/0040765 A1
(43) Pub. Date: Feb. 12, 2009

(54) LAMP ASSEMBLY COMPRISING A HIGH-PRESSURE GAS DISCHARGE LAMP

(75) Inventor: Patrick Cyriel Van De Voorde, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,416

(22) PCT Filed: Aug. 30, 2005
(86) PCT No.: PCT/IB2005/052832

§ 371 Date: Feb. 28, 2007

(30) Foreign Application Priority Data
Sep. 2, 2004 (EP) 04104226.8

(51) Int. Cl. F21V 29/02

(52) U.S. Cl. 362/294

(57) ABSTRACT

A lamp assembly comprising a high-pressure gas discharge lamp (2) and a housing (1) surrounding the lamp, as well as a reflector (3) for directing the light substantially to one direction through a transparent portion (9) of the wall of the housing (1). The housing (1) is substantially gas-tight, and cooling means (21,22,23,24,30,3 1) are present for displacing air in the housing (1). Said cooling means (21,22,23,24,30,3 1) are located inside the housing (1). Said cooling means preferably comprise a fan (21) located inside the housing (1).

The invention relates to a lamp assembly comprising a high-pressure gas discharge lamp and a housing surrounding the lamp, as well as a reflector for directing the light substantially to one direction through a transparent portion of the wall of the housing. Such a lamp assembly, comprising a high-pressure or an ultra high-pressure gas discharge lamp, in particular a mercury lamp, can be used in a beamer or in other applications in which a high-performance light source is required.

The lifetime and efficiency of such a high-pressure discharge lamp is dependent on the temperature of the lamp. The temperature should not be too high or too low and should preferably be maintained at a predetermined level. Therefore, the lamp is cooled in many applications, for example, by blowing an air flow against the lamp or by connecting parts of the lamp by means of heat-conductive materials to other parts having a lower temperature, for example, parts of the housing of the lamp. Such other parts may be provided with cooling ribs or other cooling means.

When the lamp is placed in a more or less open housing, a fan, located outside the housing, can blow air over the parts of the lamp that needs to be cooled. However, substantial cooling of the lamp may become a problem when the housing around the lamp is closed, in which case the air flow to and from the space inside the housing is limited or even blocked. Such a closed housing may be desired for safety reasons, i.e. in the case of damage of the burner of the lamp, the gas in the burner, for example, mercury, cannot reach the environment of the lamp assembly.

It is an object of the invention to provide substantial and efficient cooling of a high-pressure gas discharge lamp located in a housing, in order to extend its lifetime and improve its efficiency.

In order to achieve this object, in a lamp assembly having a substantially gas-tight housing, means are present for displacing air in the space inside the housing for cooling purposes. Substantially gas-tight is understood to mean that the housing is completely gas-tight, or that only a limited gas flow can enter or leave the housing, or that certain gases can and other gases cannot enter or leave the housing.

The moving air inside the housing can transfer heat from the burner of the lamp to the material of the housing, which material is preferably heat-conductive material, such as metal. Means such as cooling ribs may be present to cool the housing so as to decrease the temperature of the wall of the housing, so that, for example, free or forced convection of air (at the outside of the housing) can effectively lower the temperature of the housing.

In a preferred embodiment, the lamp contains mercury gas, which mercury gas cannot escape from the housing when the burner of the lamp breaks or cracks. For safety reasons, it may be desired to prevent the mercury from reaching the environment.

Said means for displacing air preferably comprise a fan, which is a reliable and effective means for displacing air. The fan may be located outside the housing, with air from the space inside the housing being sucked towards the fan and then blown back into said space. However, the fan is preferably located inside the housing, resulting in a compact lamp assembly. In another preferred embodiment, the motor of the fan is located outside the housing and the impeller of the fan is located inside the housing. Said two parts of the fan are thereby separated by the wall of the housing.

In a preferred embodiment, the space inside the housing accommodates conduits for guiding air towards one or more parts of the lamp, whereby an efficient cooling of the lamp can be achieved. An air flow is preferably directed to the central part of the bulb of the lamp, where the gas discharge takes place. The temperature is high in this central part, so that the cooling is most effective. The conduit can terminate in a nozzle located in a small hole in the reflector, the nozzle providing an air flow towards said central part of the bulb.

The lamp can be provided with two pinches at opposite sides of the bulb of the lamp for guiding an electric current into the bulb. One pinch can be located in the space surrounded by the reflector. Such pinches are made of metal and often have good heat-conductive properties. In a preferred embodiment, an air flow is directed to said one pinch. The conduit can then also terminate in a nozzle located in a small hole in the reflector, which nozzle directs an air flow towards said one pinch.

A temperature sensor is preferably present for sensing the temperature of the lamp, with control means being present for varying said displacement of air depending on the sensed temperature. In a preferred embodiment, said sensor senses the temperature of the bulb remote from said bulb, which sensor can be located in a small hole in the reflector.

The cooling intensity can be controlled by switching said means for displacing air on and off, but the intensity can also be varied by controlling the power supplied to said means. The temperature of the lamp can then be maintained at or near a certain predetermined temperature.

The housing may be completely gas-tight, but an opening in the wall of the housing is preferably provided with a gas filter through which certain gases can pass. Especially air can pass, and the gas in the burner of the lamp, for example, mercury, will be absorbed, so that it cannot escape to the environment.

The invention also relates to a method of cooling a high-pressure gas discharge lamp located inside a substantially gas-tight housing, which housing also comprises a reflector for directing the light radiation substantially to one direction through a transparent portion of the wall of the housing, the air inside the housing being displaced for cooling purposes.

The lamp assembly as described above can preferably be used in one or more of the following applications: shop lighting; home lighting; head lamps; accent lighting; spot lighting; theater lighting; office lighting; illumination of work places; automotive front lighting; automotive auxiliary lighting; automotive interior lighting; consumer TV applications; fiber-optics applications; projection systems.

The invention will now be further elucidated by means of a description of an embodiment of a lamp assembly comprising an ultra high-pressure mercury gas discharge lamp and a substantially gas-tight housing surrounding the lamp, with reference to the drawing comprising Figures which are only schematic representations, and in which:

FIG. 1 is a diagrammatic view of the lamp assembly;

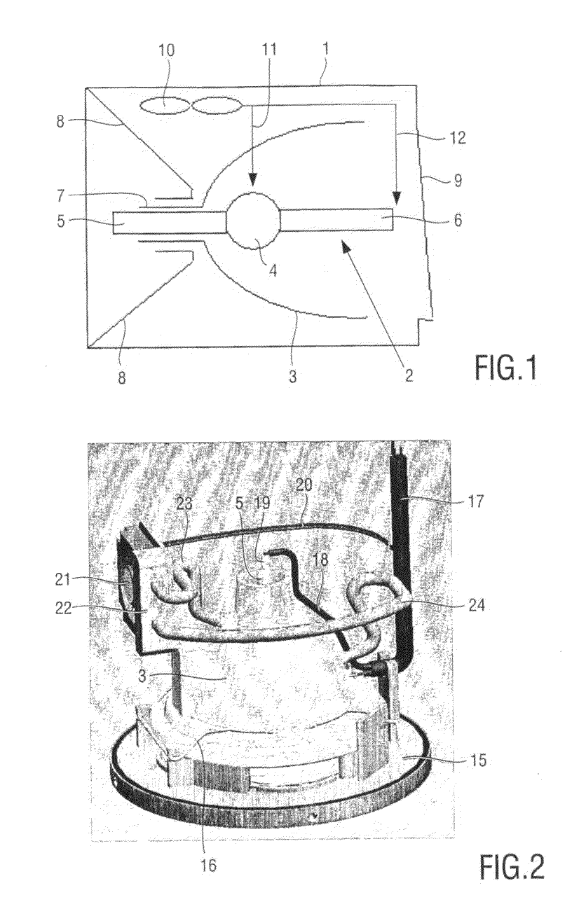

FIG. 2 is a perspective view of a portion of the lamp assembly; and

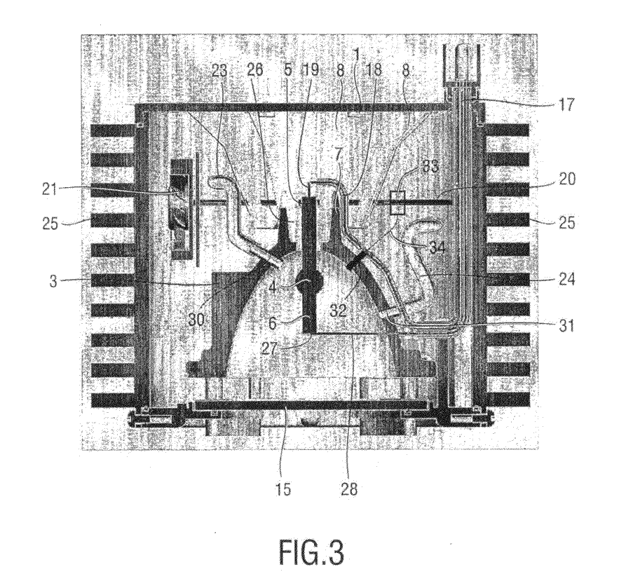

FIG. 3 is a sectional view of the lamp assembly.

The main components of the lamp assembly are represented in the diagrammatic sectional view in FIG. 1. A housing 1 surrounds a burner 2 and a reflector 3. The burner 2 has a central part 4, in which the gas discharge substantially takes place, and two elongated parts 5,6 at both sides of the central part 4. One of the elongated parts 5 of the burner 2 is fixed in a cylindrical portion 7 of the reflector 3. Members 8 are heat-conductive bridges that allow a heat to flow from the reflector 3 to the housing 1. The other elongated part 6 of the burner 2 is located in the space inside the reflector 3. Portion 9 of the housing 1 is transparent, so that the light radiation coming from the burner 2 and reflected by the reflector 3 can pass this portion 9 of the wall 1 to form a beam of light radiation outside the housing 1.

Furthermore, FIG. 1 shows a fan 10 for displacing air in the space inside the housing 1, in which air flows are directed to the central part 4 of the burner 2 and to the end of elongated part 6, as indicated by arrows 11 and 12, respectively. The burner 2 has its highest temperature in the central part 4, so that the air flow 11 ensures effective cooling. At the end of elongated part 6, there is a heat-conductive metal pinch wire entering the burner 2, so that the air flow 12 also ensures effective cooling of the burner 2. Both air flows 11,12, generated by fan 10, can continuously be directed to the central part 4 and the elongated part 6, respectively. It is also possible to direct one of the two air flows 11,12 continuously and the other only when more cooling is desired. Of course, also the intensity of one or both air flows 11,12 can be varied to maintain the temperature of burner 2 at the desired level.

FIG. 2 shows components of the lamp assembly in a perspective view, in which the housing is not present. The reflector 3 is detachably connected to a front plate 15 by means of a spring 16 pushing the reflector 3 against said front plate 15. Front plate 15 forms a part of the wall of the housing 1, which part comprises said transparent portion 9 of the wall. The burner 2 of the lamp is located in the space within the reflector 3, and only the end of elongated part 5 can be seen in FIG. 2.

FIG. 2 shows electric wires 17 for guiding an electric current to the burner 2 of the lamp, wire 18 being connected to pinch 19 at the end of elongated part 5 of the burner. Electric wires 20 guide an electric current to fan 21. Fan 21 blows air into a pressure chamber 22, and the pressurized air leaves the pressure chamber 22 through two conduits 23, 24. Each conduit 23,24 guides the air to a small hole in the reflector 3, where an air flow is blown towards the burner 2 of the lamp.

FIG. 3 shows the lamp assembly in a sectional view, in which the components of FIG. 2 are surrounded by the housing 1, which housing 1 is provided with cooling ribs 25 at the outer side of its wall. FIG. 3 shows the reflector 3 being attached to said front plate 15. The front plate 15 is a portion of the lower wall of housing 1. The burner 2 is present within the reflector 3, in which elongated part 5 of the burner 2 is fixed in the upper part 7 of the reflector 3 by means of an intermediate member 26. Members 8 connect the upper part 7 of the reflector 3 to the upper wall of the housing 1 in order to create heat-conductive bridges.

At its lower side, burner 2 is provided with elongated part 6, and pinch 27 enters the burner 2 at the end of elongated part 6. An electric current is supplied to pinch 27 through electric wire 28, which wire 28 passes the reflector 3 through a small hole in the wall of the reflector 3. A current is supplied through electric wire 18 to pinch 19 at the upper end of elongated part 5 of the burner 2. The shape of the inner surface of reflector 3 and the location of the central part 4 of burner 2 are such that an appropriate beam of light radiation leaves the lamp assembly.

FIG. 3 shows fan 21 located within the housing 1. Electric wires 20 supply an electric current to fan 21. Conduit 23 guides air, pressurized by fan 21, to a nozzle 30, which nozzle 30 is located in a small hole in the wall of the reflector 3. Nozzle 30 directs an air flow to the central part 4 of the burner 2. Conduit 24 guides air from the pressure chamber 22 (see FIG. 2) to a nozzle 31, which nozzle 31 is also present in a small hole in the wall of reflector 3. Nozzle 31 directs an air flow to the end of elongated part 6 of burner 2, where pinch 27 is located. By making use of the two nozzles 30,31, an effective cooling of the burner 2 can be obtained.

Furthermore, FIG. 3 shows a temperature sensor 32 which is located in a small hole in the wall of reflector 3. Sensor 32 can measure the temperature of the central part 4 of the burner 2. This temperature signal is guided to processor 33 by means of electric wire 34 and, depending on the sensed temperature, the fan 21 is controlled by means of the processor 33. The temperature of the burner 2 can be maintained at a predetermined level by varying the air flow through nozzle 30 and/or the air flow through nozzle 31.

The embodiment as described above is merely an example of a lamp assembly; a great many other embodiments are possible.

1. A lamp assembly comprising a high-pressure gas discharge lamp (2) and a housing (1) surrounding the lamp (2), as well as a reflector (3) for directing the light substantially to one direction through a transparent portion (9) of the wall of the housing (1), which housing (1) is substantially gas-tight, and wherein cooling means (10;21,22,23,24,30,31) are present for displacing air in the housing (1), characterized in that said cooling means (10;21,22,23,24,30,31) are located inside the housing (1).

2. A lamp assembly as claimed in claim 1, characterized in that said cooling means (21,22,23,24,30,31) are energized through the same electric wires (17) that supply an electric current to the burner (2) of the lamp.

3. A lamp assembly as claimed in claim 1, characterized in that the lamp contains mercury gas.

4. A lamp assembly as claimed in claim 1, characterized in that said cooling means comprise a fan (21).

5. A lamp assembly as claimed in claim 1, characterized in that conduits (23,24) are present inside the housing (1) for guiding air towards one or more parts of the lamp.

6. A lamp assembly as claimed in claim 5, characterized in that an air flow (11) is directed to the central part (4) of the burner (2) of the lamp, where the gas discharge takes place.

7. A lamp assembly as claimed in claim 5, in which the lamp is provided with two pinches (19,27) at opposite sides of the burner (2) of the lamp for guiding an electric current into the burner (2), one pinch (27) being located in the space surrounded by the reflector (3), characterized in that an air flow is directed to said one pinch (27).

8. A lamp assembly as claimed in claim 1, characterized in that a temperature sensor (32) is present for sensing the temperature of the lamp, with control means (33) being present for varying said displacement of air depending on the sensed temperature.

9. A lamp assembly as claimed in claim 8, characterized that said sensor (32) can sense the temperature of the burner (2) remote from said burner (2), the sensor (32) being located in a hole in the reflector (3).

10. A lamp assembly as claimed in claim 1, characterized in that an opening in the wall of the housing (1) is provided with a gas filter through which certain gases can pass.

11. A method of cooling a high-pressure gas discharge lamp located inside a substantially gas-tight housing (1), in which the housing (1) also contains a reflector (3) for directing the light substantially to one direction through a transparent portion (9) of the wall of the housing (1), characterized in that the air in the housing (1) is displaced by a fan (10;21) located inside the housing (1).
